(19) United States
(12) Patent Application Publication
(10) Pub. No.: US 2018/0086675 A1
(43) Pub. Date: Mar. 29, 2018

(54) Biotic Phosphate Fertilizers and Methods for Production

(71) Applicants: Lloyd Patrick Burchard, West Richland, WA (US); Daniel T. Hazen, Bellevue, WA (US); David E. Horn, West Richland, WA (US)

(72) Inventors: Lloyd Patrick Burchard, West Richland, WA (US); Daniel T. Hazen, Bellevue, WA (US); David E. Horn, West Richland, WA (US)

(73) Assignee: Perfect Blend, LLC, Bellevue, WA (US)

(21) Appl. No.: 15/384,307

(22) Filed: Dec. 19, 2016

Related U.S. Application Data
(60) Provisional application No. 62/400,075, filed on Sep. 26, 2016.

(51) Int. Cl. C05B 17/00; C05B 19/00; C05G 3/00

(52) U.S. Cl. CPC C05B 17/00; C05G 3/0094; C05G 3/0041; C05B 19/00

(57) ABSTRACT

Bioactive fertilizers with improved extended phosphorous availability comprise fractured animal manure waste blended with at least potassium, phosphorus and calcium, in a dried prill form, wherein the calcium is substantially bound up with phosphorus in a mineral complex and that comprises soluble organic carbon in a form that readily dissolves upon application to soil and that can bind soluble calcium in soil. Methods are also provided that fracture chicken waste with a kinetic mixer, the mixer comprising a motor operably connected to a vertical shaft within a column, the vertical shaft having a feedstock entry port at the top surface; generally flat blades extending radially from the shaft with at least one set of an even number of blades spaced apart radially at a defined distance along the vertical axis; and an exit at the shaft bottom to allow fractured feedstock to exit to a mixer; wherein the column comprises one or more walls surrounding the shaft with attached blades. After fracturing, the uncooked particles are added to coat rock phosphate, with addition of strong acid, followed by granulating, prilling and drying.

### CROSS-REFERENCE TO RELATED APPLICATIONS

This receives priority from U.S. provisional No. 62/400,075 filed Sep. 26, 2016, the entire contents of which are incorporated by reference.

### FIELD OF THE INVENTION

The disclosure generally relates to fertilizers and, in particular, to water-insoluble, enhanced quality phosphate fertilizers.

### BACKGROUND OF THE INVENTION

Phosphates are macronutrients and essential building blocks for plants and animals. Plant fertilization with phosphates, alone or in combination with nitrogen and potash fertilization, generally results in better crop yields and more nutritious food.

Phosphate fertilizers often contain diammonium phosphate (DAP), monoammonium phosphate (MAP), triple super phosphate (TSP) and other forms of phosphorus. These water-soluble compounds, however, tend to tie up in the soil, prompting the application of extra amounts that exceeds by several times the actual crop uptake, leading to poor efficiency and the contamination of water bodies.

Soil phosphorus is found in both organic and mineral form. Twenty percent to eighty percent of soil phosphorus is found in organic forms, such as phytic acid, while the rest of phosphorus is found in inorganic forms. Because most arid and semi-arid soil regimes are deficient in phosphorus, phosphatic fertilizers often are applied to replenish the phosphorus removed by harvested plants.

Plants absorb most of their phosphorus as the primary orthophosphate ion (H2PO4(4-) and a smaller amount from the secondary orthophosphate ion (HPO(4-). Plants also absorb certain soluble organic phosphates (i.e. PO(4-), nucleic acid and phytic acid).

Morphologically, the addition of phosphorus creates deeper and more abundant plant roots. Conversely, a phosphorus deficiency negatively alters root architecture, which ultimately affects seed development and normal crop maturity. Thus, the availability of soil phosphorus is fundamental for adequate stimulation of plant growth and to hasten maturity.

Despite the prevalence of phosphorus and its main useful chemical forms, phosphorus is among the least bio-available nutrients in soil. While the total amount of soil phosphorus averages to about 0.05% of soil content, only 0.1% of that amount is available to plants. Even in ideal conditions of fertile soils, very little is available at pH 6.5 where many forms are most soluble in water.

A big problem in agriculture is that more than 80% of the phosphorus applied as fertilizer often stagnates in an immobile pool due to interactions with cations such as iron and aluminum in acidic soils, and calcium in neutral and alkaline soils. This results in insolubilization, precipitation and adsorption or conversion into organic forms through biological activities. This immobilization, or “fixation” of externally supplied phosphorus is common in arid alkaline and calcareous soils because of the higher activity of the calcium. In particular, application of phosphorus to high pH soils generally favors precipitation of relatively insoluble di-calcium phosphate and other basic calcium phosphates such as hydroxyl-apatite and carbonato-apatite, which decreases the availability of applied phosphorus. Some researchers have suggested that phosphorus “fixation” in alkaline soils is mostly from retention by clays saturated with calcium. Calcium ions can bind and retain a greater amount of phosphorus compared with those saturated with sodium or other mono-violent ions. Accordingly, the formation of clay complex between ionized calcium and phosphate is believed to be the most likely culprit in hindering availability of applied phosphorus to plants.

Allen V. Barker in “Science and Technology of Organic Farming” has reviewed this problem and suggested that rock phosphate be combined with a hundred fold excess of organic waste. See page 40. However, this solution has at least two problems. One is the massive amount of carbon (as waste manure) that needs to be added for this purpose. A second is the undesirable clumping or agglomeration of organic material, which has to be cooked or incinerated to inactivate microorganisms. This causes an extraordinary demand for energy and material, which makes such blending ratio unrealistic for the purpose of mobilizing rock phosphate for enriching soil with free phosphorus.

This low availability of phosphorus to crop plants is a worldwide problem. In fact, crop yield on 30 to 40% of the world's arable land is said to be limited by phosphorus availability.

To overcome the consistent deficiency of phosphorus, especially in alkaline/calcareous soils, soluble phosphatic fertilizers are applied to agricultural fields to maximize crop production. Commercial fertilizers have played a very significant role in enhancing the per acre yield of crops.

Unfortunately, however, the current production of phosphorus fertilizers cannot meet rising demand. Because of the low use efficiency of rock phosphate due to the soil availability problem, unnecessarily high levels of rock phosphate need to be mined, with concomitant increasing prices of phosphorus fertilizers. Elevated fertilizer prices, their scarcity at the right time of application, as well as sub-optimal doses largely accounts for low phosphorus fertilizers use.

In sum, the fixation/precipitation/adsorption/transformation of phosphorus problem decreases efficiency of applied chemical phosphorus fertilizers. This prompts over use of phosphorus and over mining of rock phosphate for exogenous application of the needed substantial quantities of phosphatic fertilizers in agricultural fields.

Accordingly, any improved fertilizer or method of its manufacture that can improve availability of fertilizer phosphate to the plant would bring immense benefits to agriculture.

### SUMMARY

Desirable embodiments provide a bioactive fertilizer with improved extended phosphorous availability, comprising animal manure waste blended with at least potassium, phosphorus and calcium, in a dried prill form, wherein the calcium is substantially bound up with phosphorus in a mineral complex with a molar ratio in excess of 2:3 calcium to phosphorus in the complex, and further comprising at least 1% dry wgt/total dry wgt water soluble organic carbon (carbon based compounds such as organic acids, amino acids etc.) in a form that readily dissolves upon application to soil and that can bind soluble calcium in soil. In embodiments the bioactive fertilizer comprises at least 1%, 2%, 3%, 4%, 5%, 7% or at least 10% dry wgt percent by dry total weight colloidal clay. In embodiments the bioactive fertilizer comprises at least 2%, 4%, 5%, 7%, 10%, 15% or at least 20% dry wgt percent by dry total organic carbon containing compounds. Preferably organic carbon at these high levels are combined with colloidal clay at these high levels and are processed together with rock phosphate by addition of a concentrated form of a strong acid such as sulfuric acid or phosphoric acid during manufacture.

An embodiment provides a method for making homogeneous granular sized fertilizer from chicken waste feedstock, comprising fracturing chicken waste by a kinetic mixer, the mixer comprising a motor operably connected to a vertical shaft within a column, the vertical shaft having a feedstock entry port at the top surface; generally flat blades extending radially from the shaft with at least one set of an even number of blades spaced apart radially at a defined distance along the vertical axis; and an exit at the shaft bottom to allow fractured feedstock to exit to a mixer; wherein the column comprises one or more walls surrounding the shaft with attached blades; adding and mixing at least a source of phosphorus and potassium and sulfuric acid to form an admixture of soil nutrients; granulating the admixture of soil nutrients with a pin mixer; heating and drying the prilled admixture to form a dried prill; removing large size components from the dried prill, milling into smaller components and feeding the milled components back into admixture after the pin mixer step. In an embodiment the large size components are removed that are larger than ¼ inch and crushed and added back to the manufacturing process. In an embodiment an ammonium phosphate feedstock is added and treated with at least sulfuric acid or phosphoric acid to form a melt product.

Other embodiments will be appreciated upon reading this specification.

Strategies for Protecting Fertilizer Phosphate from Soil Sequestration with Soil Calcium.

Embodiments of the invention protect phosphorus in added fertilizer from soil sequestration and thus enhances availability of the phosphorus to the plant. Without wishing to be bound by any one theory for operation of embodiments this is achieved several alternative and/or corresponding ways:

No Separation of Ca from Counterion when Processing Rock Phosphate.

In embodiments rock phosphate is crushed and combined with organic carbon from animal manure waste that preferably has not been cooked-denatured, while mixing with a strong acid. Present technology emphasizes the need to maximize production of soluble phosphate by completely stripping the calcium away from the phosphate-calcium complex, and then providing that stripped out phosphorus to soil in a fertilizer. In contrast, desirable embodiments described herein provide complexation of this phosphorus with calcium, the phosphate substantially (at least 50%, preferably at least 75%) remains bound with calcium, but in a different form involving anionic carbon compounds and other carbon from added manure that allows bioavailability. Without wishing to be bound by any one theory for how this happens, it is believed that adding an approximately (eg. between 50% and 200%) equal amount of organic carbon to the rock phosphate during fertilizer manufacture provides a suitable coating to the rock phosphate particles. Adding colloidal clay particles at for example, 10% to 50% wgt/wgt to the rock phosphate similarly has a benefit. Preferably both are added, so that the animal manure carbon and other compounds react with the acids and by stabilizing the calcium-phosphate complexes and colloidal particles.

In this regard it is noted that preferably the amount of cationic charge from the calcium exceeds the anionic charge of the phosphate in the rock phosphate. As a result, additional negatively charged organic compounds such as organic acids, participate in binding to the (overall+charged) calcium-phosphate complexes. In an embodiment, this “additional negatively charged” material is in the form of fine clays that may be present in the rock phosphate. In a preferred embodiment, any fine clays that exist are not removed, but instead organic carbon is added that has been treated with strong acid (or that is treated with strong acid during the mixing step with rock phosphate) to create anionic charges in the carbon, thus facilitating their co-binding and stabilization of phosphate complexes and preventing their stripping out.

Unlike previous art, that strips off the calcium from phosphorus by one or more methods that substantially (at least 50%) converts the phosphate into soluble form, an excess of calcium is relied on to provide an improved form of phosphorus, in combination with added material such as oxidized (generally acidic) forms of carbon. In particular both phosphate and anionic carbon cooperate to bind up with calcium. in this regard, it was noted that co-presence of soft rock phosphate (colloidal clay particles of negative charge) also help stabilize this calcium-phosphorus mineral. In a preferred embodiment rock phosphate is treated with a strong acid in the presence of both fine clays naturally present with the rock phosphate, or added to it, and with organic carbon in the ratios described below and preferably avoids too much carbon such as two times carbon (as total carbon containing compounds in manure) to rock phosphate or more than two times carbon determined as carbon weight vs phosphorus weight. This helps stabilize the phosphate. Preferably the fine clay content is at least 1% (wgt/wgt of rock phosphate) with respect to the rock phosphate, more preferably at least 3% and yet more preferably at least 5%.

This procedure for treating rock phosphate surprisingly differs from that practiced by others in two aspects. One, rock phosphate is NOT treated alone by excess strong acid such as sulfuric acid or phosphoric acid, in order to convert all of the rock calcium into soluble form separate from the rock phosphate. Instead, organic carbon is present and processed with acid such as sulfuric acid or phosphoric acid to become further acidified and presumably participate in binding to calcium. In the industry, phosphate from rock phosphate generally is converted into soluble form by stripping out calcium with a strong acid. Other materials such as colloidal clay and organic carbon interfere with this process and are taught as needing to be removed or minimized in the conventional art.

Two, colloidal clay particles, which generally are removed prior to reaction of rock phosphate with acid in most procedures, preferably are left in or even added, due to an unexpected positive effect. Preferably at least 0.05 wgt to wgt ratio of colloidal particles to rock phosphate, more preferably at least 0.1 and yet more preferably at least 0.2 are combined. Having at least some colloidal clay provides additional protective benefit for preventing bind up of rock phosphate by soil calcium during use.

Complexing organic carbon-based material to rock phosphate mineral in the presence of a strong acid.

In a desirable embodiment animal manure (preferably not cooked-denatured) is combined with rock phosphate-calcium and acid treatment in a mixing step. For economizing on manufacturing costs, preferably all ingredients are added and mixed together during this step. As described above, it is believed that the quenching of strong acid with organic carbonaceous material leads in part to carbon-organic acid (carboxylated carbons primarily) production, where the organic acid helps protect the calcium-phosphorus complex from completely dissolving (stripping out calcium) from added acid.

The term “organic carbon” refers to carbon compounds from animal waste such as chicken waste. Water soluble organic carbon is carbon-based material that does not settle out in water but has at least some solubility in water, particularly at a suitable pH. In an embodiment, chicken waste carbon material is treated with sulfuric or phosphoric acid, which increases water solubility by increasing the proportion of anionic carboxyl residues in the organic carbon. In an embodiment this fraction is particularly desirable as a component in the fertilizer and helps the phosphorous move in the soil after application by binding to calcium and/or applied in the soil and thus preventing or alleviating immobilization of applied phosphorus. In a desirable embodiment this is present in just enough quantity to coat the rock phosphate calcium phosphate particles. Preferably the organic carbon is acid treated by mixing with a strong acid at the time of combining in a particulate form with the rock phosphate and is added at a wgt/wgt ratio of less than 5 times the rock phosphate, more preferably less than 2 times the rock phosphate.

Preferably the molar amount of added acid (preferably sulfuric acid or phosphoric acid or both) to the calcium phosphate is less than the amount needed to dissociate appreciable (more than 20%, more than 50% or more) calcium and phosphate in the rock phosphate. A skilled artisan can determine this by simple titration via adding the strong acid to a sample of rock phospate and chicken waste, mixing and grinding, and determining when the rock phosphate is liberated from binding up with calcium. In an embodiment, less than 50%, preferably less than 20% of the rock phosphate and more preferably less than 10% of the rock phosphate is liberated from the calcium.

### Unusual Methodology Provides Unexpected Results

In an embodiment, the highly unusual step of treating the rock phosphate together with a strong acid (preferably sulfuric acid, which gave best results) only in the presence of a large amount of organic carbon, leads to the formation of stabilized calcium-phosphorus complexes. This is made possible by an excess of cationic charge of the calcium, and wherein the organic carbon binds to rock phosphate particles because of this ionic effect. Accordingly, in a desirable embodiment, rock phosphate having an ionic excess of calcium with respect to phosphorous is partially melted with strong acid in the presence of organic residue carbon (in ratios described below). This allows the protection of phosphorus by co-binding of calcium with both phosphorus and organic carbon for a more suitable substrate for soil feeding.

Furthermore, subsequent processing creates a layered prill. This unusual mixture (combination of rock phosphorus with strong acid and with organic carbon in the ratios described below) surprisingly led to superior fertilizer. The resultant fertilizer provided unexpectedly good late season results where phosphorus feeding of roots was surprisingly enhanced. In one case of organic onions, preplant broadcast application of the fertilizer prepared as described in Table 1 provided near record yields of onions which presented greater bulb size due to better root systems and enhanced nutrient uptake. Onions have commonly weak root systems and the improved phosphorus availability from the fertilizer composition described herein is believed to successfully address this issue. Use of the fertilizer at 700 pounds per acre on organic potatoes also led to an observed significant decrease in pink rot. It is believed that phosphorus may be an important factor in some controls for pink rot and that the greater availability of phosphorus from the fertilizer may be responsible for this unexpected effect.

These surprising enhancements are thought to arise from at least one of two unusual conditions of the fertilizer. One, rock phosphate is not simply stripped from calcium before adding as soluble phosphorus to a subsequent fertilizer mixture, but instead is processed in the presence of a large amount of organic carbon, which helps stabilize the calcium phosphorous. Two, adding an excess of acid treated organic carbon helps protect phosphorus in the fertilizer from becoming bound up to soil calcium and directly helps phosphorus feeding to the plants. Also adding colloidal clay (which is negatively charged) contributes to these effects.

Phosphorus Release from Rock Calcium

In an embodiment, at least 10% of the rock calcium is removed from complexation with phosphorus and instead becomes complexed to added acid such as carbon-based acids from the animal manure, and thus is hindered from binding phosphate. In another embodiment, at least 20% of the rock calcium becomes complexed to added acid such as carbon-based acids from the animal manure. In another embodiment, at least 35% of the rock calcium becomes complexed to added acid such as carbon-based acids from animal manure. In yet another embodiment at least 50% of the rock calcium becomes complexed to added acid such as carbon-based acids from animal manure. In yet another embodiment at least 75% of the rock calcium becomes complexed to added acid such as carbon-based acids from animal manure.

In an embodiment, these complexation figures refer to carbon-based organic acid that is created at least in part by the addition and mixing of strong acid such as phosphoric acid or sulfuric acid to the animal manure carbon. Preferably the interaction between calcium and carbon-based compounds (and/or added acid) is facilitated by combining and mixing the relevant components, such as chicken waste, added sulfuric or phosphoric acid, and rock phosphate together in a large container with mixing. Preferably a strong acid such as sulfuric acid or phosphoric acid is added by dripping, squirting, misting or flowing a concentrated water solution of the acid into such container, at the same time as, or followed by agitating.

In an embodiment, 25 to 200 pounds of sulfuric acid or phosphoric acid are added for each 500 pounds of rock phosphate and 500 to 2600 pounds of chicken waste or other animal waste. Preferably the animal waste contains 20-60% water, preferably 20-40% water, more preferably 20-35% water, but for purposes of these combinations, is assumed to contain 20% water. Also, preferably the waste, such as chicken waste, contains 25% to 35% organic carbon (which includes, inter alia, leftover feed, partially digested feed, fecal microbes, oxidized waste products from the body etc.). For purposes of determining ratios with other fertilizer raw ingredients, the chicken waste preferred embodiment contains 30% organic carbon and 20% water.

In a preferred embodiment, 25 to 200 pounds of sulfuric acid or phosphoric acid are added for each 500 pounds of rock phosphate and 1000 to 1300 pounds of chicken waste or other animal waste. In a more preferred embodiment, 50-100 pounds of sulfuric acid or phosphoric acid are added for each 500 pounds of rock phosphate and 500 to 2600 pounds of chicken waste or other animal waste. In a most preferred embodiment, 50-100 pounds sulfuric acid or phosphoric acid are added for each 500 pounds of rock phosphate and 1000-1300 pounds of chicken waste or other animal waste. Most preferably the acid is added to a mixture of rock phosphate diluted with organic carbon material such as animal waste. However other organic waste (optionally treated with acid to increase anionic character) such as waste sugarbeet residue, waste from paper pulp making, seaweed and the like may be used.

### Excess Organic Carbon-Based Acids in the Prepared Fertilizer

In a preferred embodiment strong acid such as phosphoric acid and/or sulfuric acid is added to organic carbon from animal waste (and preferably chicken waste) to form an excess of carbon-based free organic acid that accompanies phosphate when added to soil. Preferably, on a free carbon acid anion basis, the amount of (primarily negatively charged carboxyl groups) available for binding in the prepared fertilizer is at least 10% the molar amount of free phosphorus. More preferably the amount of acid organic carbon is at least 50% of the phosphorus and more preferably at least 100% of the phosphorus. In an embodiment, the stochiometric amount of titratable carboxyls exceeds the amount of phosphorus and preferably is a least two times the amount of phosphorus.

It will be appreciated by a skilled artisan that much of the organic carbon molecules will contain multiple anionic charges and will chelate free anions such as calcium. These multiply anionic carbon compounds are created, at least in part by addition of strong acid to animal carbon waste during fertilizer manufacture. Without wishing to be bound by any one theory for operation of this embodiment, it is believed that the multiply anionic carbon-based material in excess binds calcium in the soil, and thereby prevents soil calcium from immobilizing added phosphate, and providing the unexpected results.

Forming Layers of Treated Carbon-Based Coatings with Phosphate-Calcium.

Preferred fertilizer described herein is made in the form of pellets with concentric layers wherein each layer includes both organic material (generally including carbon-based anionic acids) and calcium-phosphate and preferably colloidal clay comprising calcium-phosphate. Each pellet comprises (on average) at least 3 layers and more preferably at least 5 layers.

In an embodiment enough organic acid from the manure is added to constitute a large fraction (preferably at least 1% by dry weight, more preferably at least 25 by dry weight) of the pellets. This allows the organic acid in the fertilizer during application to soil, to enter the soil and bind up calcium (and other multivalent cations) in the soil, thus protecting against immobilization of added phosphate by those same multivalent cations.

Including Colloidal Clay Particles of Calcium Phosphate from “Soft” Rock Phosphate.

Addition of colloidal clay anionic particles to rock phosphate complexes formed during fertilizer is believed to further stabilize the rock phosphate complexes. It was surprisingly appreciated that fertilizers having high colloidal clay particle content provided superior phosphate delivery to plants, as seen by superior plant growth, particularly in late season.

### Animal Manure Waste Combined to Make Desirable Fertilizer

Preferably an animal manure is kinetically fractured without cooking to facilitate preservation of molecular structure (and water solubility) of molecular components in a first step. This is followed by addition of the fractured material to the rock phosphate and other components such as strong acid as described, for example in U.S. Pat. Nos. 8,246,711 and 8,425,648.

The term “animal manure waste” means waste matter excreted from animals as feces and/or urine, such as but not limited to that from human (municipal sewage or sludge), cattle (beef, dairy, buffalo, veal, etc.), horses, sheep, swine, poultry (chicken, turkey, ostrich, pigeon, etc.), goat, mink, veterinarian, stockyard, stable, race track, rodeo grounds, fairgrounds, feedlot, sale barn, confined animal feeding operations, zoo, aquatic (fish, shrimp, etc.), elk (and other game), llama, alpaca, as well as other operations and sources of sewage or animal waste, and any mixtures thereof. animal manure waste as used herein includes such matter along with other materials normally present in agricultural operations where such matter is produced, such as straw, bedding (which is typically shredded paper, wood chips, etc.), hair, feathers, insects, rodents, etc., whether the ratio of such matter to such other materials ranges from very low to very high. animal manure waste includes matter in its raw form, any prepared form and mixtures thereof with other materials such as other bio matter (yard waste, green waste, etc.), additives, process aids, bone meal, fish meal and the like, including where the matter is fresh, fully bioconverted by composting, digestion, etc., or is at any stage in between.

In an embodiment, the animal manure waste typically has a moisture content between about 25% and about 70% by weight, preferably between about 20% and about 30% by weight and most preferably between about 30% and about 40% by weight. “Percent by weight,” as used herein, is in reference to percent of the component in question based on the total weight of the mixture referred to. Animal manure waste of lower moisture content, for example, as low as about 10% by weight or even about 20% by weight can be processed in embodiments. The solids content in many embodiments is primarily organic solids and microorganisms, and when obtained from mammals, particularly fecal coliforms. As used herein “microorganism” is used to include bacteria, protozoa, fungi and algae.

In an embodiment extra phosphate is added in a form such as ammonium phosphate. This is particularly desirable when a large amount of acid treated organic carbon is included in the mixture to form fertilizer. Preferably ammonium phosphate is introduced in a final wgt/wgt ratio of between 10-25 percent of the total mixture and more preferably between 15-20 percent of the total mixture.

### Conversion Into Suitable Form

Optionally, the feedstock is converted into a physical form most suited for the particular mechanical shock technique used to kill anaerobic (and facultative anaerobic) bacteria therein. In an embodiment, the animal manure waste is processed for mechanical shock by mechanical means, such as a front end loader, which drops the feedstock into a rock separator, mixer, and chopper unit. The feedstock can be further mixed and foreign objects separated in screw conveyers, then processed by mechanical shock. The feedstock also can be pre-mixed or conditioned for desired uniformity prior to loading into this system by a loader, e.g., in storage windows that can be combined and mixed.

Different animal feedstock can be processed by different methods prior to conversion into suitable fertilizer, as will be appreciated by a skilled artisan. In an embodiment, the goal of such pre-process is to decrease the moisture content of the solid product as much as possible, while separating and treating the contained moisture for reuse as gray water (e.g. wash water or irrigation water).

A wet feedstock, such as regular hog manure, should undergo a process to separate the solids from moisture before the solids can be converted into a topsoil microorganism feeding fertilizer. Dairy manure feedstock often is in two forms: a liquid form prepared by automated manure collection process, and a dry form when a farmer collects the manure with a tractor from loafing areas. The wet manure may undergo a separation process such as, for example, described in U.S. Pat. No. 6,863,826 (“Animal waste effluent treatment”). A screw press separator or other equipment also can be used to separate liquids from the solids. Poultry manure can be used as a feedstock as is, or may undergo a drying step before use.

### Mechanical Shock (Mechanical Composting) at Limited Temperature Via a Kinetic Processor

The feedstock initially has viable bacteria, viruses, weed seeds, insect eggs, and other organisms that generally become inactivated at this stage without use of high heat (above 107 degrees Centigrade). These organisms constitute a large proportion of the wet mass and are mechanically shocked (preferably in the presence of air or oxygen gas) to remove their viability. This treatment also has an effect on other microbes in the feedstock, but preferably, a later heating and drying step is used to bring the total microbial viability load down to an acceptable level.

In an embodiment the organic waste is fractured by a kinetic mixer before adding to rock phosphate. This facilitates coating of rock phosphate particles with (minus charged) organic carbon. In an embodiment adding more than 5 times (and preferably more than 2 times) organic carbon as manure to the particles is strictly avoided to prevent excessive agglomeration. Fracturing of animal waste and preferably chicken waste results in average particle sizes of less than 10 mm, preferably less than 5 mm, more preferably less than 2 mm and yet more preferably less than 1 mm (average long axis diameter).

Without wishing to be bound by any one theory for this embodiment, it is believed that by first coating and then heating/drying at a higher temperature to form a dried prill, the stability and later solubility over time in the soil of the rock phosphate with particularized organic material in natural (non-denatured—non cooked/incinerated) form is enhanced. Cooked manure has less water soluble acidic groups that can readily bind to and coat particles in the processing procedure.

In an embodiment, the mechanical shock separates cells in the presence of oxygen, allowing oxidative killing or weakening of the cells. In a preferred embodiment, the mechanical shock is sufficient to break and thereby kill, bacterial cells and other microorganisms. In many cases, the feedstock has a large proportion of gram negative bacteria, which have cell walls. In an embodiment, mechanical activity (kinetic shock by collision with a metal wall, sonic air shock, or sonic shock in solution) mechanically shocks the bacteria enough to inactivate them.

Mechanical shock by kinetic thrashing preferably is used, wherein bits of the feedstock collide at more than 200, preferably more than 250, and yet more preferably more than 300 and most preferably about 350 miles per hour onto a solid surface such as an armored steel plate. Preferably the feedstock is accelerated in a cooling fluid air stream mixed with air and enters a turbulent stream of air that helps separate the particles, while accelerating them prior to collision. This process generally can inactivate most of the bacteria of the feedstock without cooking.

Sonication shock by high pressure sound waves in a fluid medium may be used to fracture the waste and incidentally inactivate microbes of the feedstock without subjecting them to high (e.g. above 200 degrees Fahrenheit) temperatures. For example, in batch mode, animal waste may be treated with sonic energy. In a continuous process, such as that described by Sheets (see U.S. Pat. No. 6,863,826, particularly the methods and energy usage per gram material), low sonic energy may be used per kilogram of dry matter and cooking is avoided. Optionally, a flow stream thus treated may be further processed by the addition of micronutrients and chelater as described below.

In a desirable embodiment, an animal manure waste is not composted, incinerated or substantially cooked, but instead mechanically treated, to rupture organisms and microorganisms enough to make them non-viable. Rather than turn the feedstock into cinders, or into relatively insoluble, sticky goo, the feedstock nutrients are converted into smaller particles in natural form that can bind to rock phosphate surfaces. Desirably, at least 30%, 40%, 50% or more of the nutrients (carbon, nitrogen and minerals) are in a soluble (i.e. undenatured) form. The prepared fertilizer in fact is a more potent soil builder because more nutrients are available in a more soluble form and thus readily available for use. More importantly, the fractured material can chemically (via ionic attraction) and/or mechanically bind to rock phosphate surfaces to allow gradual release after application to soil.

Yet another advantageous feature is the control of pH to a pH of 5.0 and 6.5 and preferably about 6.1. The term “about 6.1” means pH of between 5.8 to 6.4 and more preferably between pH 6.0 to pH 6.2. Animal wastes on the other hand, generally are alkaline and often well above pH 7. Lower pHs near 5 and less than 6 are preferred.

### Rock Phosphate

Embodiments use rock phosphate as an ingredient that is combined with organic waste (animal waste, preferably chicken waste) and processed into a form that resists bind up of phosphorus by soil calcium after subsequent application to soil as a fertilizer.

Rock phosphate is a raw material used for manufacturing fertilizer. Desirable embodiments include phosphorite, phosphate rock or rock phosphate, which is a non-detrital sedimentary rock that contains high amounts of phosphate bearing minerals. The phosphate content of phosphorite preferably is at least 15 to 20%. If it is assumed that the phosphate minerals in phosphorite are hydroxyapatite and fluoroapatite, phosphate minerals contain roughly 18.5% phosphorus by weight and if phosphorite contains around 20% of these minerals, phosphorite is roughly 3.7% phosphorus by weight, which is a considerable enrichment over the typical sedimentary rock content of less than 0.2%. The phosphate is present as fluorapatite Ca₅(PO₄)₃F (CFA) typically in cryptocrystalline masses (grain sizes <1 μm) referred to as collophane. It is also present as hydroxyapatite Ca₅(PO₄)₃OH or Ca₁₀(PO₄)₆(OH)₂, which is often dissolved from vertebrate bones and teeth, whereas fluorapatite can originate from hydrothermal veins. Other sources also include chemically dissolved phosphate minerals from igneous and metamorphic rocks. Phosphorite deposits often occur in extensive layers, which cumulatively cover tens of thousands of square kilometres of the Earth's crust.

All rock phosphate sources are desirable in embodiments. Globally, there are four major types of phosphate resources, including marine, igneous, metamorphic and biogenic phosphate deposits which contain either of the flour-apatite (Ca.sub.10(PO.sub.4).sub.6F.sub.2), hydroxy-apatite (Ca.sub.10(PO.sub.4).sub.6(OH).sub.2), carbonate-hydroxy-apatite (Ca.sub.10(PO.sub.4CO.sub.3).sub.6(OH).sub.2), francolite, dahllite, and cellophane compounds. (Straaten, 2002.) Reserves are primarily found in Northern Africa, China, the Middle East, United States, Brazil, Canada, Finland, Russia and South Africa. Large phosphate resources have also been identified on the continental shelves and on seamounts in the Atlantic and the Pacific Ocean.

The desired grade of rock phosphate for manufacturing classic chemical fertilizers is one having 30% P.sub.20.sub.5 or higher, with low silica, magnesium and other elements. Reserves of these grades are declining. A number of physio-chemical processes are employed to improve P.sub.20.sub.5 content of low-grade rock phosphate and to remove undesired elements. Physical and thermal up gradation of rock phosphate is achieved through crushing & screening, scrubbing, de-sliming, flotation and magnetic and gravitation separation. However, a substantial amount of energy is consumed and environmental pollutants are released in these processes.

Rock phosphate often shows a considerable proportion of isomorphic substitution in the crystal lattice and has a variable proportion and amounts of accessory minerals and impurities. In a desirable embodiment, rock phosphate is known as phosphorite and generally is known as the formula (Ca+2)5Y(PO4)3 wherein Y is one or more of F—, Cl—, and OH—. Another major form of phosphate is fluorapatite (Ca5(PO4)3F , typically in cryptocrystalline masses of grain size less than one micron. Total phosphate may be for example 20-50% and preferably 30-37% and more preferably 32-35%, calcium oxide content preferably is 40-60%, more preferably 46-54% and yet more preferably 48-52%. Preferably moisture is less than 5%, more preferably less than 2%. The rock phosphate used preferably is in powder form or granular form and is directly added to a mixing chamber with animal manure, a strong acid, and other nutrients such as sulfur, ammonium sulfate, potash and trace minerals.

Colloidal Clay (Preferably from the Rock Phosphate Material)

The term “colloidal clay” refers to the easily suspended colloidal form of mineral that accompanies deposits of rock phosphate and that is often termed “soft rock phosphate.” Soft rock phosphate is found in the clay layers surrounding hard rock phosphate deposits . Generally soft rock phosphate is about 20% total phosphate, 3% is readily available, the remaining 17% is released by microbial activity, although this varies with deposits. In a desirable embodiment, at least 1% of the total rock phosphate used is “soft rock phosphate” consisting of clay layers, but in more desirable embodiments this material is at least 2%, 5% or even 10% or more, by total weight of the mined product.

In an embodiment the soft rock phosphate colloidal clay component has at least 10%, more preferably at least 20% (wgt/total wgt of mined material) readily available calcium. The colloidal clay particles do not dissolve in water but are suspended in it. They stay close to the surface suspended in water not being lost by leaching out of the soil. In this colloidal form they do not combine with other elements but remain available for plants to use as needed.

In a preferred embodiment, the colloidal clay particles are negatively charged and coat the larger, hard rock phosphate particles, which preferably have an excess of calcium cationic charge during the mixing treatment with acid.

### Additional Inorganic Elements

Embodiments provide phosphate fertilizers; the provision of water-insoluble phosphate fertilizers, the provision of dilute acid-soluble fertilizers, the provision of phosphate fertilizers optionally containing at least one nutrient ion selected from the group consisting of potassium, sodium, ammonium, boron, chromium, cobalt, copper, iodine, iron, manganese, molybdenum, selenium, sulfur and zinc. In a preferred embodiment, the phosphate fertilizers are in the form of free-flowing powders and pellets.

An embodiment uses a water-insoluble, dilute acid-soluble inorganic polyphosphate (“phosphate”) composition in solid crystalline form, the inorganic polyphosphate composition containing calcium, magnesium or a combination thereof, 5 to 70 wt % orthophosphate, and optionally one or more micronutrient metals selected from the group consisting of chromium, cobalt, copper, iron, manganese, and zinc, with the proviso that the inorganic polyphosphate composition contains no more than 5 wt. % of the micronutrient metal(s), in combination, and no more than 3.5 wt % iron when iron is the only micronutrient. Iron may be considered to be the only micronutrient when the composition comprises no more than 0.01 wt. % of each of chromium, cobalt, copper, manganese, and zinc.

Upon combination with animal waste as a fertilizer, the phosphate composition may optionally contain, in addition to one or more of ammonium, boron, chromium, cobalt, copper, iodine, iron, manganese, molybdenum, potassium, selenium, sodium, sulfur and zinc, other components that contribute to the nutritional, material handling, or other characteristics of the fertilizer. For example, the prepared fertilizer composition may contain a water-soluble N-P-K macronutrient fertilizer composition that has been blended or otherwise combined with the composition. By way of further example, the fertilizer may contain additional organic materials such as plant residues that have been blended or otherwise combined with the micronutrient phosphate composition to improve the material handling characteristics of the fertilizer. In an embodiment the composition further comprises microorganism cultures that promote soil health.

In an embodiment, the phosphate composition substantially comprises calcium as the only cation (other than protons). The term “substantially” in this context mean more than 90% by weight of total cations. In such embodiments, the ratio of the combined number of moles of phosphorus, sulfur, boron, molybdenum, selenium (incorporated in the phosphate, sulfate, borate, molybdate and selenate repeat units) to moles of calcium in the calcium phosphate may be greater than 0.5:1, respectively. By way of further example, the ratio of the moles of phosphorus, sulfur, boron, molybdenum, selenium (incorporated in the phosphate, sulfate, borate, molybdate and selenate repeat units) to moles of calcium in the calcium phosphate may be greater than 0.66:1, respectively. By way of further example, the ratio of the moles of phosphorus, sulfur, boron, molybdenum, selenium (incorporated in the phosphate, sulfate, borate, molybdate and selenate repeat units) to moles of calcium in the calcium phosphate may be greater than 1.1:1, respectively. By way of further example, the ratio of the moles of phosphorus, sulfur, boron, molybdenum, selenium (incorporated in the phosphate, sulfate, borate, molybdate and selenate repeat units) to moles of calcium in the calcium phosphate may be greater than 1.67:1, respectively.

In another embodiment, the rock phosphate composition comprises substantially calcium and magnesium as the only cations (other than protons). The term “substantially” in this context means more than 90% by weight. For example, the ratio of moles of calcium to moles of magnesium may be greater than 1:1, respectively. By way of further example, the ratio of the moles of calcium to moles of magnesium may be greater than 2:1, respectively. By way of further example, the ratio of the moles of calcium to moles of magnesium may be greater than 4:1, respectively. By way of further example, the ratio of the moles of calcium to moles of magnesium may be greater than 5:1, respectively. By way of further example, the ratio of the combined number of moles of phosphorus, sulfur, boron, molybdenum, and selenium (incorporated in the phosphate, sulfate, borate, molybdate and selenate repeat units) to moles of calcium and magnesium (in combination) in the phosphate may be greater than 0.67:1, respectively. By way of further example, the ratio of the combined number of moles of phosphorus, sulfur, boron, molybdenum, and selenium (incorporated in the phosphate, sulfate, borate, molybdate and selenate repeat units) to moles of calcium and magnesium (in combination) in the phosphate may be greater than 0.74:1, respectively. By way of further example, the ratio of the combined number of moles of phosphorus, sulfur, boron, molybdenum, and selenium (incorporated in the phosphate, sulfate, borate, molybdate and selenate repeat units) to moles of calcium and magnesium (in combination) in the phosphate may be greater than 0.83:1, respectively.

By way of further example, the ratio of the combined number of moles of phosphorus, sulfur, boron, molybdenum, and selenium (incorporated in the phosphate, sulfate, borate, molybdate and selenate repeat units) to moles of calcium and magnesium (in combination) in the phosphate may be greater than 0.95:1, respectively. By way of further example, the ratio of the combined number of moles of phosphorus, sulfur, boron, molybdenum, and selenium (incorporated in the phosphate, sulfate, borate, molybdate and selenate repeat units) to moles of calcium and magnesium (in combination) in the phosphate may be greater than 1.1:1, respectively. By way of further example, the ratio of the combined number of moles of phosphorus, sulfur, boron, molybdenum, and selenium (incorporated in the phosphate, sulfate, borate, molybdate and selenate repeat units) to moles of calcium and magnesium (in combination) in the phosphate may be greater than 1.33:1, respectively. By way of further example, the ratio of the combined number of moles of phosphorus, sulfur, boron, molybdenum, and selenium (incorporated in the phosphate, sulfate, borate, molybdate and selenate repeat units) to moles of calcium and magnesium (in combination) in the phosphate may be equal to 1.67.1, respectively.

In certain embodiments, the ratio of the moles of phosphorus to moles of calcium and magnesium (in combination) in the phosphate may be greater than 0.5:1, respectively. By way of further example, the ratio of the moles of phosphorus to moles of calcium and magnesium (in combination) in the phosphate may be greater than 0.67:1, respectively. By way of further example, the ratio of the moles of phosphorus to moles of calcium and magnesium (in combination) in the phosphate may be greater than 0.74:1, respectively. By way of further example, the ratio of the moles of phosphorus to moles of calcium and magnesium (in combination) in the phosphate may be greater than 0.83:1, respectively. By way of further example, the ratio of the moles of phosphorus to moles of calcium and magnesium (in combination) in the phosphate may be greater than 0.95:1, respectively. By way of further example, the ratio of the moles of phosphorus to moles of calcium and magnesium (in combination) in the phosphate may be greater than 1.1:1, respectively. By way of further example, the ratio of the moles of phosphorus to moles of calcium and magnesium (in combination) in the phosphate may be greater than 1.33:1, respectively. By way of further example, the ratio of the moles of phosphorus to moles of calcium and magnesium (in combination) in the phosphate may be equal to 1.67.1, respectively.

In an embodiment, the phosphate composition comprises calcium, magnesium and one nutrient ion as the only cations (other than protons). For example, alkaline earth metal phosphate composition may comprise only calcium and magnesium and zinc as the only cations (other than protons). By way of further example, the ratio of the combined number of moles of phosphorus, sulfur, boron, molybdenum and selenium incorporated in the repeat units to moles of zinc in the phosphate may be greater than 5:1, respectively. By way of further example, the ratio of the moles of phosphorus to moles of zinc in the phosphate may be greater than 5:1, respectively. By way of further example, the ratio of the combined number of moles of phosphorus, sulfur, boron, molybdenum and selenium incorporated in the repeat units to moles of zinc in the phosphate may be greater than 10:1, respectively. By way of further example, the ratio of the moles of phosphorus to moles of zinc in the phosphate may be greater than 10:1, respectively. By way of further example, the ratio of the combined number of moles of phosphorus, sulfur, boron, molybdenum and selenium incorporated in the repeat units to moles of zinc in the phosphate may be greater than 20:1, respectively. By way of further example, the ratio of the moles of phosphorus to moles of zinc in the phosphate may be greater than 20:1, respectively.

### Strong Acid Component

In the preferred procedures, a strong acid such as sulfuric acid and/or phosphoric acid is added to the animal manure and rock phosphate in a mixing step. When applying sulfuric acid, the amount of acid added preferably is in a final ratio of between 10 pounds and 400 pounds of 95% sulfuric acid per 4000 pounds of manure and more preferably between 20 pounds and 200 pounds of 95% sulfuric acid per 4000 pounds of manure when the manure has a water content of between 10 and 30 percent.

### Method for Making Fertilizer From the Components

Methods for making fertilizer having the described materials preferably follow several themes, which differ generally from that practiced by others. One theme is the use of rock phosphate without stripping the phosphate out. This is achieved by strong acid treatment in the presence of an equal (eg. 50-200% ratio as wgt/wgt) or greater (eg. 2-5 times) amount of organic carbon, which reacts with the strong acid. Another theme is the high levels of organic carbon and optionally, colloidal clay, which surprisingly provides enhanced mobility in soil during use of the fertilizer. Another optional theme is the formation of prill with concentric layers, which helps facilitate application and favorable dissolution characteristics during soil treatment. Another optional theme is the use of lower pH of the final fertilizer for enhanced performance. Another optional theme is the avoidance of denaturing temperatures on the organic carbon before and during the complexation step with acid and with rock phosphate. Another optional theme is the enhanced homogeneity of size prill by recycling large pieces that make it past the drying stage.

In step 1 of the procedure, animal manure waste is prepared for adding to a mixture. Preferably the animal waste is fractured by a kinetic mixer. Preferably the humidity of the fractured animal manure waste material generated from this step is between 5 and 40%, and more preferably between 10 and 30 percent. In an embodiment chicken manure having 10 to 35% water is fractured via a kinetic processor, which forms particles at low temperature of typically less than 150 degrees Fahrenheit, particularly less than 110 degrees Fahrenheit, and more desirably less than 100 degrees Fahrenheit. Preferably a kinetic processor such as that described by U.S. 20090188290 is used. The procedures and materials and definitions of terms described in that patent application are particularly incorporated by reference. In an embodiment other components such as rock phosphate are included in the kinetic processor.

In step 2 of the procedure, fractured manure waste is combined with rock phosphate (and optionally but preferably colloidal clay) and strong acid component, and optionally other components such as ammonium sulfate, urea, trade minerals and the like, in a mixing chamber. The fractured manure waste is mixed with rock phosphate at near equal amounts (wgt/wgt between 20:80 and 80:20 ratio, preferably between 40:60 ratio and 50:50 ratio). The acid component (preferably sulfuric acid or phosphoric acid but other acids may be used) preferably is sprayed or sprinkled into the mixing chamber. During this addition and mixing, the pH of the animal manure—rock phosphate bulk material drops to between 5 and 7 and preferably between 6.1 and 6.7. The material heats up in this step, preferably between 30 and 80 degrees centigrade and more preferably between 50 and 65 degrees centigrade. During this step, preferably a homogeneous mixture is formed.

In step 3, the homogeneous mixed material from step 2 is subjected to granulation (optionally by adding an additional binder or sealant) or prilling in a granulator or priller. Prilling without further material addition is preferred for the sake of economy, although variations that preserve the organic matter/rock phosphate composition can be used. Preferably during prilling, homogeneous concentric layers are built up within each pellet. The term “homogeneous” means that the basic composition of organic carbon, rock phosphate, and P, K, N generally does not differ on average more than 20% between layers. Preferably at least 2 layers, more preferably at least 3 layers and even more preferably at least 5 layers are present in an average prill of size at least 2 mm (longest axis measured).

In step 4, the prilled (or granulated) material is dried to remove moisture and provide a product with a more stable product shelf-life. The pellets or granules from the agglomeration process are typically a wet product. Thus, the method preferably comprises a step for drying the pellets to a lower humidity. Preferably, the pellets are dried to less than 25% by weight of moisture, more preferably less than 10% by weight of moisture, and even more preferably less than 5% by weight of moisture. The pellets may for example, be dried according to any of the methods described in relation to drying the powder.

For example, a preferred temperature for drying the pellets can be determined by the presence and quality of a binder, if used. In the absence of a binder, the preferred temperature is as described in relation to drying the powder or pellet. In a preferred embodiment, pellets are dried by high air temperature from combustion of natural gas or propane. In the presence of a binder, the preferred temperature for drying the pellets is from 5 to 30 degrees C. less than the melting point of the binder, and most preferably about 20 degrees C. less than the melting point of the binder. For instance, when the pellets comprise a polymeric binder, such as polyethylene glycol, the pellets may be dried at a temperature of up to 70 degrees C., preferably up to 60 degrees C., and more preferably up to 50 degrees C. When AD liquor is used as the binder, the pellets may be dried at a temperature of up to 125 degrees C., preferably up to 115 degrees C., and more preferably up to 105 degrees C. For economy, pellets are dried directly without any additions and a drying tunnel is used, with prilled material conveyed on a conveyor belt.

The method may further comprise the step of screening the pellets for size. This quality control step involves passing the, preferably dried, pellets through a set of sieves to remove undersized (fines) and over-sized (coarse) pellets from the product. As mentioned above, the preferred pellet size is from 2 to 4 mm. In an embodiment, pellets that are undersized, for example smaller than 2 mm, may be recycled to the agglomeration (granulator or prilling) unit. In a preferred embodiment pellets that are oversized, for example larger than 6 mm (determined as maximum dimension plus or minus 20%) are crushed, for example by a hammer mill. The crushed oversized pellets may then be recycled to the agglomeration unit.

The method may further comprise the step of adding a coating to the pellets. The coating is preferably as described above. The coating may be applied using methods known in the art. For instance, the coating may be applied via a process of fluidized bed coating. Preferably, however, a prilling step is used wherein the material forms layers.

The method may further comprise the step of packaging the pellets. In the packaging step, the product meeting the size and nutrient composition requirements is packed into suitable units, such as boxes, bags or cartons.

In an embodiment, the method further comprises the step of forming one or more layers on the surface of the core material, such that the fertilizer comprises at least two different nutrient release profiles. The one or more layers is/are preferably as described above. The step of forming one or more layers on the surface of the core material may comprise the sub-steps of providing a seed pellet, and layering particles with different release profiles onto the seed pellet.

### EXAMPLE

Table one, presented below, summarizes a representative composition for a desirable fertilizer made according to an embodiment.

| % s: | Moisture | Total N | P | P2O5 | K | K2O | S | B |
|---|---|---|---|---|---|---|---|---|
| Dry | 0 | 3.88 | 6.35 | 14.55 | 1.27 | 1.53 | 0.64 | 51.3 |
| Matter | | | | | | | | |
| Basis | | | | | | | | |
| Undried | 4.13 | 3.72 | 6.09 | 13.95 | 1.22 | 1.47 | 0.61 | 49.2 |
| Basis | | | | | | | | |

| | Zn | Mn | Cu | Fe | Ca | Mg | Na | Cl | pH |
|---|---|---|---|---|---|---|---|---|---|
| Dry | 454 ppm | 320 ppm | 52.5 ppm | 2872 ppm | 13.35% | .52% | .31% | .93% | |
| Matter | | | | | | | | | |
| Basis | | | | | | | | | |
| Undried | 435 ppm | 307 ppm | 50.3 ppm | 2753 ppm | 12.80% | .50% | .30% | .89% | 5.4 |
| Basis | | | | | | | | | |

### Ionic Excess of Calcium Over Phosphorus in the Rock Phosphate

In a desirable embodiment, it was surprisingly found that rock phosphate having 0.205 moles of phosphorus for every 0.33 moles of calcium (ionic excess of calcium to phosphorus, assuming dianionic phosphorus complexes with oxygen) worked well. Preferably the calcium is in a ratio of at least 10% greater ionic excess to phosphate that is between 50% and 200% of this measured value. In an embodiment clay colloidal particles bind to calcium of rock phosphate particles based on the excess of calcium vs phosphate in the calcium-phosphate complexes.

Each citation to art is specifically incorporated by reference in their entirety.

Space limitations preclude further description of embodiments that readily will occur to a skilled artisan. For example one or more components such as those described as alternative embodiments and optional embodiments may be omitted and added. All such embodiments especially in combinations and possible permutations are intended within the ambit of the attached claims and future amended claims. The term “about” means the stated value plus and minus 10% of the stated value. The term “total weight” means the total prepared weight, including any moisture in the preparation or materials. Additional embodiments include embodiments, wherein “total weight” is replaced by “total dry weight” wherein moisture in the preparation or materials is not included in the determination.

We claim:

1. A bioactive fertilizer with improved extended phosphorous availability, comprising:
fractured animal manure waste blended with at least potassium, phosphorus and calcium, in a dried prill form, wherein
the calcium is substantially bound up with phosphorus in a mineral complex with a molar ratio in excess of 2:3 calcium to phosphorus in the complex,
and further comprising between 1% to 5% dry wgt/total dry wgt water soluble organic carbon in a form that readily dissolves upon application to soil and that can bind soluble calcium in soil.

2. The bioactive fertilizer of claim 1, comprising at least 1% dry wgt percent by dry total weight colloidal clay.

3. The bioactive fertilizer of claim 2, comprising at least 2% dry wgt/total dry wgt water soluble organic carbon.

4. The bioactive fertilizer of claim 2, comprising at least 4% dry wgt/total dry wgt water soluble organic carbon.

5. The bioactive fertilizer of claim 2, wherein the clay is in particle form surrounding calcium-phosphate particles produced from rock phosphate.

6. The bioactive fertilizer of claim 4, comprising at least 2 percent by total weight colloidal clay.

7. The bioactive fertilizer of claim 1, comprising between 6 percent to 18 percent dry wgt/total dry wgt phosphate.

8. The bioactive fertilizer of claim 1, in a granular prill form of size sufficient for passage of 50% through a 100 mesh.

9. The bioactive fertilizer of claim 1, comprising at least 2% dry wgt/total dry wgt water soluble organic carbon, at least 2% by total weight colloidal clay, and comprising between 6 percent to 18 percent dry wgt/total dry wgt phosphate.

10. The bioactive fertilizer of claim 1, comprising at least 4% dry wgt/total dry wgt water soluble organic carbon, at least 4% by total weight colloidal clay, and comprising between 6 percent to 18 percent dry wgt/total dry wgt phosphate.

11. A bioactive fertilizer with improved extended phosphorous availability, comprising:
fractured animal manure waste comprising organic carbon in acidic forms blended with at least potassium, phosphorus and calcium, in a dried prill form, and comprising
at least 20% by wgt/total wgt rock phosphate wherein the phosphorus of the rock phosphate has not been stripped from the calcium but has formed a complex with organic carbon bound to mineral complexes of calcium and phosphorus,
and comprising 1-5% by wgt/total weight soluble organic carbon, which can bind to soil calcium upon application as a fertilizer to a soil.

12. The bioactive fertilizer of claim 11, comprising no more than 1% by wgt/total weight soluble organic carbon, which can bind to soil calcium upon application as a fertilizer to a soil.

13. The bioactive fertilizer of claim 11, further comprising at least 2% by wgt/total weight colloidal clay particles.

14. The bioactive fertilizer of claim 11, comprising no more than 2% by wgt/total weight soluble organic carbon, which can bind to soil calcium upon application as a fertilizer to a soil.

15. A method for making homogeneous granular sized fertilizer from chicken waste feedstock, comprising:
fracturing chicken waste by a kinetic mixer, the mixer comprising a motor operably connected to a vertical shaft within a column, the vertical shaft having a feedstock entry port at the top surface; generally flat blades extending radially from the shaft with at least one set of an even number of blades spaced apart radially at a defined distance along the vertical axis; and an exit at the shaft bottom to allow fractured feedstock to exit to a mixer; wherein the column comprises one or more walls surrounding the shaft with attached blades;
adding and mixing at least a source of phosphorus and potassium and sulfuric acid to form an admixture of soil nutrients;
granulating the admixture of soil nutrients with a pin mixer;
heating and drying the prilled admixture to form a dried prill;
removing large size components from the dried prill, milling into smaller components and feeding the milled components back into admixture after the pin mixer step.

16. The method of claim 15, wherein large size components are removed that are larger than ¼ inch.

17. The method of claim 15, further comprising treating an ammonium phosphate feedstock with at least sulfuric acid or phosphoric acid to form a melt product and adding the acid treated ammonium phosphate feedstock.

18. The method of claim 15, wherein the heating and drying step comprises heating the prilled admixture to about 175-190 degrees Fahrenheit for about 15 to 35 minutes.

19. The method of claim 15, wherein the admixture of soil nutrients comprises at least 2% soluble carbon by wgt/total weight.

20. The method of claim 19, wherein the admixture of soil nutrients further comprises at least 2% colloidal clay by wgt/total weight.
